(19) United States
(12) Patent Application Publication
(10) Pub. No.: US 2017/0307183 A1
(43) Pub. Date: Oct. 26, 2017

(54) LAMP ASSEMBLY WITH UNIVERSAL BASE

(71) Applicant: Lighting Science Group Corporation, Cocoa Beach, FL (US)

(72) Inventors: Mark Penley Boomgaarden, Satellite Beach, FL (US); Yong Jiang, Melbourne, FL (US)

(73) Assignee: Lighting Science Group Corporation, Cocoa Beach, FL (US)

(21) Appl. No.: 15/407,348

(22) Filed: Jan. 17, 2017

Related U.S. Application Data
(60) Provisional application No. 62/327,859, filed on Apr. 26, 2016.

(51) Int. Cl. F21V 17/00; F21V 23/02; F21V 19/00; F21V 17/16; F21V 5/04; F21K 9/237; F21K 9/235; F21V 7/06; F21K 9/238; F21V 23/06; F21V 29/80; F21Y 2115/10

(52) U.S. Cl. CPC F21V 17/007; F21V 23/06; F21V 23/023; F21V 19/006; F21V 17/16; F21V 17/002; F21V 29/80; F21V 5/04; F21K 9/237; F21K 9/235; F21V 7/06; F21K 9/238; F21Y 2115/10

(57) ABSTRACT

Embodiments of the present invention are related to a lamp assembly that may have a base unit that includes a base, a power supply housing, a power supply, and a power supply cover. The base unit may be operable to detachably engage a lamp unit to form a functional lighting device. Furthermore, the base unit may be operable to be interchanged with a plurality of lamp units.

### RELATED APPLICATIONS

This application is related to and claims priority under 37 CFR 1.119 to U.S. Provisional Patent Application Ser. No. 62/327,859, titled Collapsible Luminaire filed Mar. 26, 2016 (Attorney Docket No. 221.00253) the contents of which is incorporated herein in its entirety by reference, except to the extent disclosure therein is inconsistent with disclosure herein.

### FIELD OF THE INVENTION

The present invention relates to a lamp assembly with a universal base and associated methods.

### BACKGROUND

Packaging of traditional lamps involves orienting the bulbs in a manner that places them vertically parallel to each other. In this configuration, however, the bases are at one end of the packaging and the optics are at the other, which requires a larger box and more shelf space in a retail outlet. The structure of traditional lighting has involved a base and housing with a much narrower diameter and surface space than the optical chamber. In fact, a traditional optic is quite bulbous and the diameter and surface area may be more than five times larger than its base. Therefore, packaging traditional lighting in a vertically parallel fashion minimizes space efficiency since the wide, bulbous portion of the lighting devices are laid next to each other. To overcome this disadvantage, manufacturers have packaged the bulbs in an alternating inverse orientation so that the bases and optics of adjacent lighting devices are positioned at opposite ends of the packaging. This enables the space adjacent the smaller base of one bulb to be accommodated by the much larger diameter of the optical chamber of another bulb within the same packaging. Orienting the bulbs in an inverse manner may provide a small space advantage over the traditionally packaged bulb, however, the structure of the lighting devices themselves do not allow for more efficient packaging.

The structure of the present invention provides a markedly improved space efficiency over the traditionally packaged bulb. The detachability of the lamp allows multiple units to be efficiently packaged in a manner that aligns them vertically parallel. Furthermore, the lamp's shape reduces the problems associated with bulbous traditional lighting. As a result, more surface area of a plurality of detached lighting devices are able to symmetrically occupy a smaller packaging space than non-detachable lighting.

Another disadvantage of traditional lighting is the lack of adaptability with consumer trends. In order for a consumer to change the look of their lighting system, traditional lighting requires that the entire lighting device be replaced. Since most consumers have multiple lighting devices, this requires replacing multiple lighting devices. The present invention allows a consumer to replace only the lamp unit portion of the lighting device in order to keep pace with design trends in lighting. This means that the consumer will only pay for a portion of the lighting device instead of the entire device. Furthermore, with the present invention installation only requires fitting the lamp unit into an already existing base unit.

Along those same lines, with traditional lighting a consumer wishing to replace the size of their lighting device must replace the entire lamp. With the present invention, the interchangeability of the base unit with multiple lamp units allows for a consumer to easily change the size of their lighting device to suit their needs without replacing the entire device.

Another disadvantage of traditional lighting units is the inability for manufacturers to warrant the individual components. Under traditional methods, if a lighting device is defective, a manufacturer must replace the entire device under most warranties since the devices are integrated. With the detached componentry of the present invention, a manufacturer may separately warrant the base unit and the lamp unit. Furthermore, the modularization of both units facilitates the ability for warranties to be placed on the componentry that makes up the base unit and the lamp unit. This serves as an advantage to both the consumer and the manufacturer. Instead of a manufacturer having to replace an entire defective lighting device, the manufacturer may only need to replace a smaller, less expensive component. This savings can therefore be passed on to the consumer since the consumer will only be paying for the less expensive replacement component.

A further disadvantage of the traditional structure of lighting devices is the relatively small surface area of the power supply. The smaller the surface area, the more difficult and therefore expensive it becomes to mass produce them. The unique design of the present invention permits an elongate power supply that is easily slid into and out of the lighting device. This allows for a larger surface area for production, which in turn means easier, less expensive manufacturing costs. Likewise, the ease by which the power supply may be inserted and removed from the base unit allows for easier manufacturing and less expensive production costs.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a lamp assembly that may have a base unit that includes a base, a power supply housing, a power supply, and a power supply cover. The base unit may be operable to detachably engage a lamp unit to form a functional lighting device. Furthermore, the base unit may be operable to be interchanged with a plurality of lamp units.

The lamp assembly may comprise a lamp unit operable to detachably engage the base unit. The lamp unit may comprise a frame, a connector board, a heat plate, a plurality of light-emitting diodes (LEDs) and an optic. In some embodiments the lamp unit may be disk shaped. Furthermore, the LEDs may be packaged as a chip on board (COB) light source module.

The lamp assembly may include the power supply with a circuit board that comprises a connector segment with power connection features defined as a power supply connector. The lamp unit may comprise a connector board segment with power connection elements defined as a lamp connector. The power supply connector and the lamp connector may be operable to matingly engage one another and detachably attach the base unit to the lamp unit.

The power supply cover may be attached to one end of the power supply housing and the base may be attached to an opposing end of the power supply housing.

The lamp assembly may include a lamp unit frame assembly configured to carry the lamp connector, the heat plate, and the LEDs. In this embodiment the lamp unit frame assembly may be operable to snap fit with the optic.

The power supply cover may include a medial aperture configured to allow at least a portion of the power supply connector to pass through the power supply cover and extend outwardly from one end of the base unit.

The circuit board may be elongated and the power supply unit housing may form an elongate body configured to enclose the elongate circuit board.

The power supply cover may be removable from one end of the power supply unit housing, and the power supply may be operable to slide into and out of the power supply unit housing.

The invention may include a lamp assembly kit comprising a base unit, a lamp unit, and a box sized to carry both a base unit and a lamp unit that are not engaged with each other. However, the base unit and the lamp unit may be operable to detachably engage one another to form a functional lighting device.

The lamp assembly kit box may be operable to carry a plurality of base units such that longitudinal axes of the base units are aligned parallel to one another. Furthermore, the lamp assembly kit box may be operable to carry a plurality of lamp units such that longitudinal axes thereof are aligned parallel to one another. The plurality of base units and the plurality of lamp units may be carried within the box, but may not be engaged with each other. Furthermore, the box may be sized to accommodate at least one of a BR30, BR40, PAR 30, PAR 38, PAR 20, PAR 30SN and R 20.

The lamp assembly kit may include one end of the base unit comprising one of a screw base or pin base. Furthermore, the lamp assembly kit may have the base unit with an elongate polyhedral member and the lamp unit being disk shaped. In some embodiments the lamp assembly kit may include the base unit body as an elongate cylindrical member.

In some embodiments the lamp assembly may comprise a base unit that includes a base, a power supply unit housing, a power supply, and a power supply cover. The lamp assembly may further include a lamp unit comprising a frame, a connector board, a heat plate, a plurality of light-emitting diodes (LEDs) and an optic. In this embodiment the base unit may be an elongate member and the lamp unit may be a disk shaped member. Furthermore, the base unit and the lamp unit may be configured to detachably engage one another to form a functional lighting device. In this embodiment the power supply may further include a circuit board that comprises a connector board segment with power connection elements defined as a power supply connector. Additionally, the lamp unit comprises a connector board segment with power connection elements defined as a lamp connector, wherein the power supply connector and the lamp connector are configured to fittingly engage one another and detachably attach the base unit to the lamp unit. In this embodiment the lamp unit may comprise a frame, a connector board, and a heat plate wherein the LEDs are packaged as a chip on board (COB) light source module.

### BRIEF DESCRIPTION OF THE DRAWINGS

FIG. 1a is a perspective view of a lamp assembly with an attached base unit according to an embodiment of the present invention.

FIG. 1b is a perspective view of the lamp assembly of FIG. 1a with a detached base unit.

FIG. 2a is a perspective view of the base unit of the lamp assembly illustrated in FIGS. 1a and 1b.

FIG. 2b is an exploded perspective view of the base unit illustrated in FIG. 2a.

FIG. 3 is an exploded perspective view of a lamp unit of the lamp assembly illustrated in FIGS. 1a and 1b.

FIG. 4 is a perspective view of one embodiment of the base unit of the lamp assembly illustrated in FIG. 2a and corresponding lamp units of the lamp assembly capable of receiving the base unit.

FIG. 5 is a perspective view of another embodiment of the base unit of the lamp assembly illustrated in FIG. 2a and corresponding lamp units of the lamp assembly capable of receiving the base unit.

FIG. 6 is a perspective view of yet another embodiment of the base unit of the lamp assembly illustrated in FIG. 2a and corresponding lamp units of the lamp assembly capable of receiving the base unit.

FIG. 7 is a perspective view of a lamp assembly kit in packaging according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a lamp assembly with a universal base.

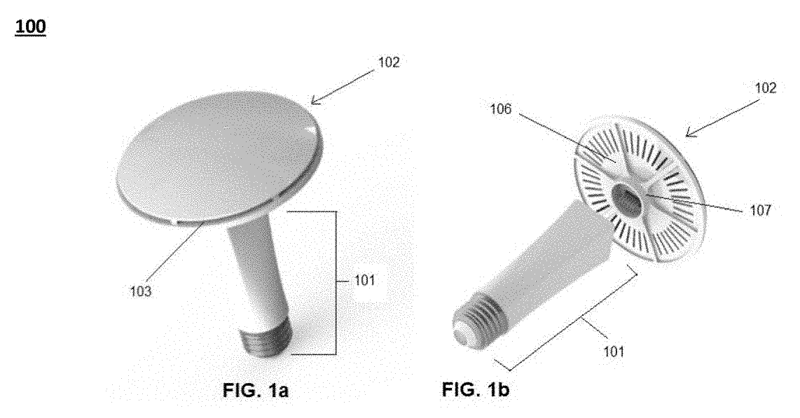

Referring to FIGS. 1a and 1b, a lamp assembly 100 according to an embodiment of the invention is presented. The lamp assembly 100 may include a base unit 101 and a lamp unit 102. The base unit 101 may be attached to an exterior surface of the lamp unit 102, defined as the lamp unit lower surface 106, in order to form a functioning monolithic luminaire. However, as shown in FIG. 1b, the base unit 101 and the lamp unit 102 may be two distinct components that detachably engage one another.

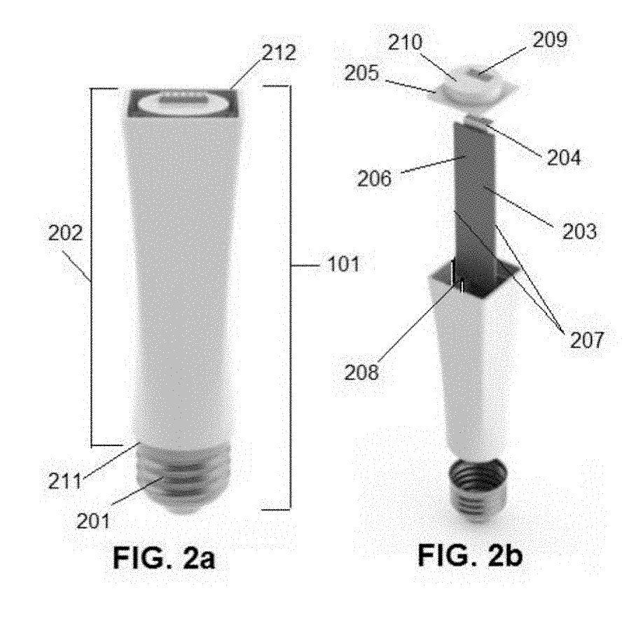

Referring now additionally to FIGS. 2a and 2b, the base unit 101 may include a base 201, a power supply housing 202, a power supply 203, a power supply connector 204, and a power supply cover 205. At one end of the base unit 101 may be the base 201. The base 201 may be a screw base, including an Edison base, that is attachable to a first end 211 of the power supply housing 202. In some embodiments, the base 201 may be crimp fit onto the first end 211 of the power supply housing 202. The power supply housing 202 may be an elongated polyhedral member with a hollow interior. In one embodiment the power supply housing 202 may resemble a rectangle with a first end 211 that corresponds in size to the base 201 and a second end 212 larger than the first. In this embodiment the cross-sectional dimensions of the power supply housing 202 may taper from the second end of the power supply housing 202 to the first end.

The second end 212 of the power supply housing 202 may be an opening configured to allow the power supply 203 to be positioned within the hollow interior power supply housing 202. In one embodiment the hollow interior of the power supply housing 202 may include a pair of grooves carved into two opposing planar surfaces in order to form a track 208 to receive the power supply 203. The track 208 may not only facilitate the power supply 203 sliding into and out of the power supply housing, but may also facilitate securing the power supply 203 inside the power supply housing 202. In an alternative embodiment the track 208 may be formed with interior walls that create a rectangular chamber sized to secure the power supply in place within the hollow interior of the power supply housing 202.

The power supply 203 may be a flat rectangular circuit board comprising circuitry on a planar surface 206 thereof. The length of the power supply 203 may be such that it permits the power supply 203 to be positioned at least partially within the power supply housing 202. In some embodiments, the length of the power supply 203 may be equal to or less than the length of the power supply housing 203. Likewise, the width of the power supply 203 may be such that it permits the power supply 203 to be positioned within the hollow interior of the power supply housing 202. The power supply 203 may include edges 207 that may or may not abut interior planar surfaces of the power supply housing 202.

The power supply 203 may further comprise opposing ends. A power supply connector 204 may be attached to a first end of the power supply 203. The power supply connector 204 may be electrically coupled to the power supply 203. Additionally the power supply connector 204 may be configured to both fittingly and electrically engage the lamp unit 102. In one embodiment the power supply connector 204 may extend distally from the first end of the power supply 203 and likewise project distally from the second end 212 of the power supply housing 202. The projected power supply connector 204 may be configured to fit through a cover medial aperture 209 of the power supply cover 205.

In some embodiments the power supply cover 205 may be configured to overlay the second end of the power supply housing 202 that opposes the base 201. However, the cover 205 may be secured to the power supply housing 202 in a number of ways including friction/interference fit, epoxy, soldering or the like. The power supply cover 205 may serve to seal off one end of the power supply housing 202 that would otherwise expose its hollow interior and encapsulated circuitry. The power supply cover 205 may comprise a cover medial aperture 209 that may be sized to accommodate the permeation of the power supply connector 204 and establish a seal with the power supply connector 204 so that the power supply cover 205 seals off the hollow interior of the power supply housing 202.

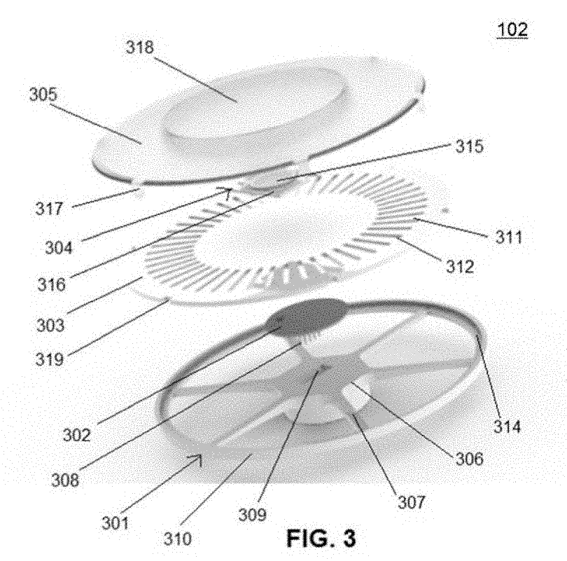

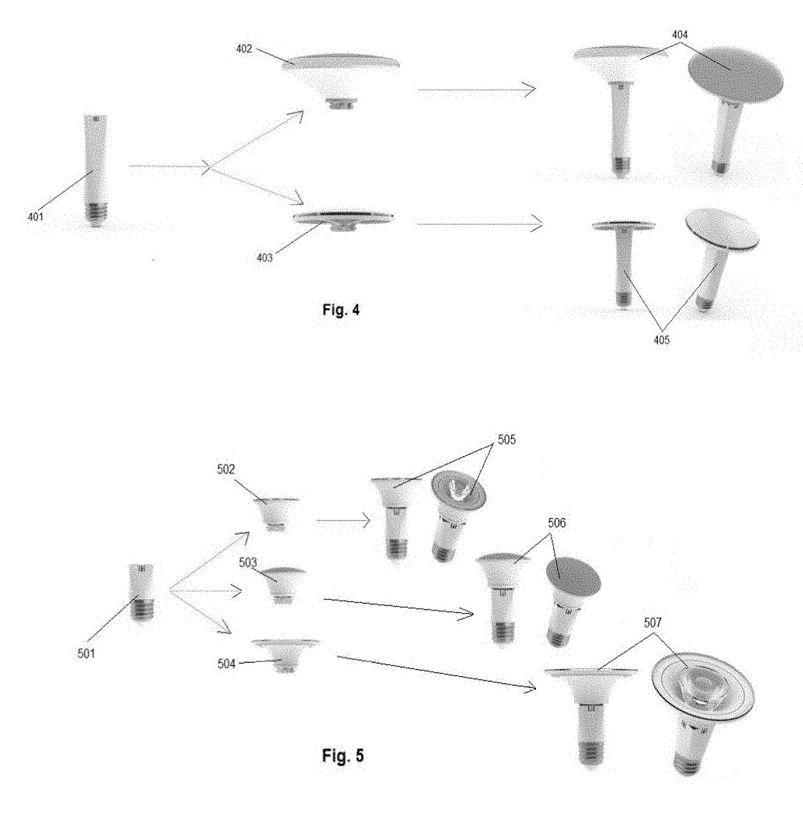

Referring now to FIG. 3, the lamp unit 102 may be an assembly that forms a disk-shaped lamp unit 102 as depicted in FIGS. 1a and 1b. The lamp unit 102 may include a frame 301, a connector board 302, a heat plate 303, a lighting element 304, and an optic 305. The frame 301 may serve as the foundation of the lamp unit 102 and may be circular in shape, although any geometric configuration is contemplated and included within the scope of the invention. The frame 301 may include a hub 306 at its center that may be a circular nucleus with a smaller perimeter than a larger outside frame perimeter 310. A plurality of elongate fins may extend distally from the hub 306 and attach to the frame perimeter 310. The plurality of fins 307 may conduct heat away from the hub 306 and lighting element 304 toward the frame perimeter 310. Furthermore, the plurality of fins 307 may be spaced at a distance from each other necessary to minimize the transference of thermal energy between them.

A connector board 302 may be positioned on an upper surface of the hub 306. The connector board 302 may be laid on the hub 306 or may be fastened by thermally conductive paste, screws, epoxy, or the like. Attached to one surface of the connector board 302 may be a cluster of power connection elements collectively defined as a lamp connector 308. The lamp connector 308 may be configured to matingly engage the power supply connector 204 of the base unit 101 and detachably attach the base unit 101 to the lamp unit 102. The lamp connector 308 may extend distally from a surface of the connector board 302 and may be configured to permeate a hub medial aperture 309. This allows the lamp connector 308 to pass through the lamp unit lower surface 106, which enables it to fittingly and electrically connect with the power supply connector 204 of the base unit 101.

Surrounding the connector board 302 but located within the frame perimeter 310 may be a heat plate 303. The heat plate 303 may be positioned inward from and be retained by a rim 314 of the frame perimeter 310. The heat plate 303 may be disk shaped and may include an inner perimeter and an outer perimeter. Heat dissipating spokes 311 may be elongate members that extend from the inner perimeter of the heat plate 303 to its outer perimeter. The heat dissipating spokes 311 may facilitate the conduction of heat away from the hub 306 and the lighting element 304 toward the frame perimeter 310. Furthermore, the heat dissipating spokes 311 may be spaced at a distance from each other necessary to create cooling apertures 312. The cooling apertures 312 may allow for ambient air to ventilate the lamp unit 102 and cool the lamp unit 102 componentry.

Located on the connector board 302 may be the lighting element 304. The lighting element 304 may include light emitting diodes (LEDs) 315, which may be assembled as a chip on board (COB) light source module. The lighting element 304 may include a platform 316 that serves as a foundational surface for the LEDs 315 to rest atop. The platform 316 may be made of thermally conductive material that facilitates the conduction of heat away from the LEDs 315 and through to the heat plate 303 and frame 301. In some embodiments the platform 316 may include a circuit board delivering electrical circuitry to the LEDs 315. Likewise, the connector board 302 may also serve as a means to deliver electrical circuitry to the LEDs 315. The platform 316 may be fastened to the hub 306 via screws that pass through screw holes located thereon. The screws may pass through screw holes located on the platform 316, the connector board 302 and the hub 306 in order to secure the lighting element 304 to the hub 306 within the lamp unit 102. This allows the lighting element 304 to be securely placed in optical communication with the optic 305.

The optic 305, which includes a lens 318, encapsulates the connector board 302, the heat plate 303, and the lighting element 304 between itself and the frame 301. The optic 305 may be disk shaped and configured to snap fit within the rim 314 of the frame perimeter 310. Optic fasteners 317 located on the perimeter of the optic 305 extend in a direction distal to the optic lens 318 and may be configured to matingly engage the rim 314. The optic fasteners 317 may extend past the heat plate 303 at designated points defined as notch points 319 located in the heat plate 303 outer perimeter. The optic fasteners 317 fitted through the notch points 318 may serve to stabilize the heat plate 303 thereby preventing the heat plate 303 from prolapsing within the lamp unit 102.

In some embodiments the optic fasteners 317 may be of a sufficient length and spaced apart at a sufficient distance to create a ventilation gap 103 (FIG. 1a) between the optic 305 and the frame 301. The ventilation gap 103 may further provide a means for ambient air to ventilate the lamp unit 102 componentry. In additional embodiments, the optic perimeter may be formed to create a reflective lip so as to prevent light produced by the lighting element 304 from escaping through the ventilation gap 319.

Referring now additionally to FIGS. 1b and 2b, the lamp unit a-lower surface 106 of the lamp unit 100 may be an exterior surface located opposite the optic 305 that is defined in combination by the frame 301, the heat plate 303, and the hub 306. Accordingly, the hub 306 on the lamp unit lower surface 106 may form a connection enclosure 107 that extends outward from the lamp unit lower surface 106 and surrounds the protruding lamp connector 308. The connection enclosure 107 is sized to receive a portion of the power supply cover 205 on the base unit 101 that extends outwardly therefrom. This outwardly extended portion of the power supply cover 205 is defined as a cover extension 210. The cover extension may surround the cover medial aperture 209 and is sized to fittingly engage the connection enclosure 107.

The base unit 101 and the lamp unit 102 may be attached as a monolithic unit when the cover extension 210 is fitted inside the connection enclosure 107 and the lamp connector 308 is fittingly engaged with the power supply connector 204. Similarly, the base unit 101 and the lamp unit 102 may be detached from each other when the cover extension 210 is removed from inside the connection enclosure 107 and the lamp connector 308 is disengaged from the power supply connector 204.

The advantages of having a base unit 101 that is detachable from the lamp unit 102 can be seen in FIGS. 4-7. FIG. 4 is an exemplary embodiment of one of those advantages. It demonstrates a bulged reflector (BR) base unit 401 shown with a first lamp unit 402 and a second lamp unit 403. Both lamp units 402, 403 may be differently sized and shaped. However, the BR base unit 401 is able to connect with either of the first lamp unit 402 or the second lamp unit 403 to form a monolithic lamp sized as a BR40 labeled as 404 or a BR30 labeled as 405.

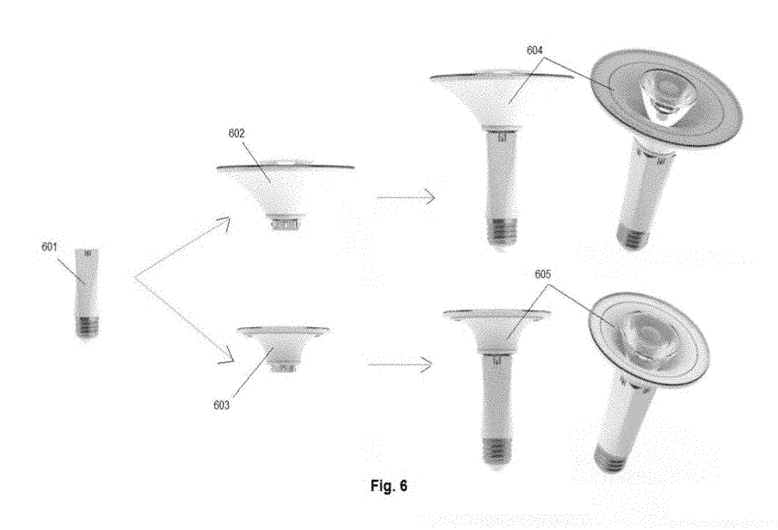

FIG. 5 shows the versatility of the detachable base unit 101 as a PAR base unit 501 that may be applied to a series of parabolic aluminized reflector (PAR) lamp units 502, 503, 504. In this example, the PAR base unit 501 is applied to lamp units 502, 503, 504 to form a variety of monolithic lamps including a PAR20 labeled as 505, a PAR30 SN labeled as 507, and an R20 labeled as 506. The R20 labeled as 506 is sized the same as a BR20.

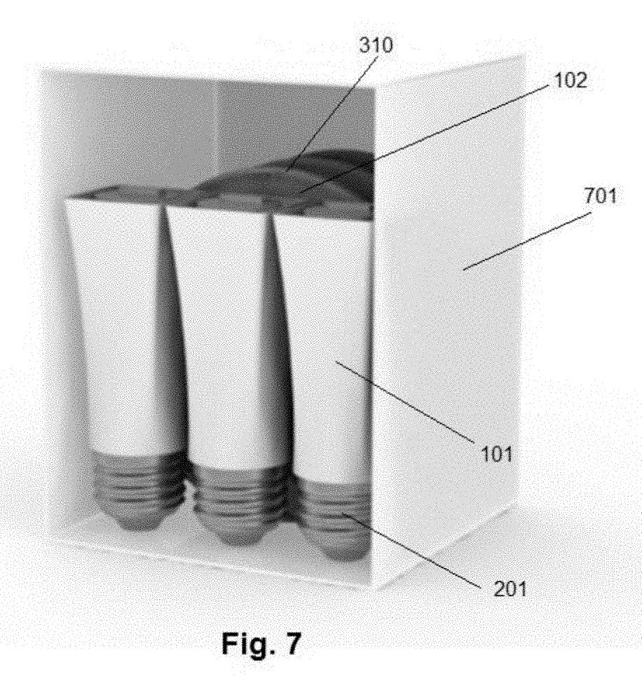

FIG. 6 is another exemplary embodiment of the versatility of a detachable base unit 101. It demonstrates a PAR base unit 601 shown with a first lamp unit 602 and a second lamp unit 603. Both lamp units 602, 603 may be differently sized and shaped. However, the PAR base unit 601 is able to connect with either of the first lamp unit 602 or the second lamp unit 603 to form a monolithic lamp sized as a PAR38 labeled as 604 or a PAR30 labeled as 605.

It should be noted that FIGS. 4-6 are exemplary only and are not meant to be limiting in any fashion. They are merely demonstrative of the versatility of a detachable base unit 101. Further demonstration of the versatile advantages of a detachable base unit 101 are shown by FIG. 7.

FIG. 7 shows the packaging benefits of having a luminaire with detachable componentry. In this embodiment the base units 101 are detached and vertically aligned so as to efficiently make use of the shape of a packaging box 701. Similarly, the lamp units 102 are detached and aligned in a row adjacent the base units 101 within the same packaging box 701. It should be noted that the orientation of the packaging box 701 may slightly alter the description of how the lamp unit 102 and base unit 101 are packaged. In FIG. 7 the components are vertically aligned so that the base units 101 are standing on their bases 201. Likewise, the lamp units 102 are vertically aligned so that they are standing single file on the frame perimeter 310 behind the base units 101. However, if the packaging box 701 were to be laid on its posterior and viewed from above, the lamp units would be resting on the lamp unit lower surface 106 and stacked vertically on each other. This would place the base units 101 in a row on top of the lamp units 102 with a majority of the base units 101 surface area being the power supply housing 202 resting on a single lamp unit 102 stacked on top of the other lamp units 102. However, no matter the orientation of the packaging box 701, FIG. 7 demonstrates the potential for a manufacturer to package several lighting devices in a box 701 dimensioned to fit only one or two traditional lighting devices.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A lamp assembly comprising:
a base unit comprising:
a base;
a power supply housing;
a power supply; and
a power supply cover;
wherein the base unit is operable to detachably engage a lamp unit to form a functional lighting device.

2. The lamp assembly according to claim 1 wherein the base unit is operable to be interchanged with a plurality of lamp units.

3. The lamp assembly according to claim 1 further comprising a lamp unit operable to detachably engage the base unit, wherein the lamp unit comprises a frame, a connector board, a heat plate, a plurality of light-emitting diodes (LEDs) and an optic.

4. The lamp assembly according to claim 3 wherein the lamp unit is disk shaped.

5. The lamp assembly according to claim 3 wherein the plurality of LEDs are packaged as a chip on board (COB) light source module.

6. The lamp assembly according to claim 3 wherein the power supply comprises a circuit board that comprises a connector segment with power connection features defined as a power supply connector; wherein the lamp unit comprises a connector board segment with power connection elements defined as a lamp connector; and wherein the power supply connector and the lamp connector are operable to matingly engage one another and detachably attach the base unit to the lamp unit.

7. The lamp assembly according to claim 6 wherein the power supply cover is attached to one end of the power supply housing and the base is attached to an opposing end of the power supply housing.

8. The lamp assembly according to claim 6 further comprising a lamp unit frame assembly configured to carry the lamp connector, the heat plate, and the plurality of LEDs; wherein the lamp unit frame assembly is operable to snap fit with the optic.

9. The lamp assembly according to claim 6 wherein the power supply cover comprises a medial aperture configured to allow at least a portion of the power supply connector to pass through the power supply cover and extend outwardly from one end of the base unit.

10. The lamp assembly according to claim 9 wherein the circuit board is elongated, defining an elongate circuit board; and wherein the power supply housing forms an elongate body that is configured to enclose the elongate circuit board.

11. The lamp assembly according to claim 1 wherein the power supply cover is removable from one end of the power supply housing and the power supply is operable to slide into and out of the power supply housing.

12. A lamp assembly kit comprising:
a base unit;
a lamp unit; and
a box sized to carry both a base unit and a lamp unit that are not engaged with each other;
wherein the base unit and the lamp unit are operable to detachably engage one another to form a functional lighting device.

13. The lamp assembly kit according to claim 12 wherein the box is operable to carry a plurality of base units such that longitudinal axes thereof are aligned parallel to one another, and a plurality of lamp units such that longitudinal axes thereof are aligned parallel to one another; and wherein the plurality of base units and the plurality of lamp units are not engaged with each other.

14. The lamp assembly kit according to claim 12 wherein the box is sized to accommodate at least one of a BR30, BR40, PAR 30, PAR 38, PAR 20, PAR 30SN and R 20.

15. The lamp assembly kit according to claim 12 wherein one end of the base unit comprises one of a screw base or pin base.

16. The lamp assembly kit according to claim 12 wherein the base unit is an elongate polyhedral member and the lamp unit is disk shaped.

17. The lamp assembly kit according to claim 12 wherein the base unit body is an elongate cylindrical member.

18. A lamp assembly comprising:
a base unit comprising:
a base;
a power supply housing;
a power supply; and
a power supply cover; and
a lamp unit comprising:
a frame;
a connector board;
a heat plate;
a plurality of light-emitting diodes (LEDs); and
an optic;
wherein the base unit is an elongate member and the lamp unit is a disk shaped member; and
wherein the base unit and the lamp unit are configured to detachably engage one another to form a functional lighting device.

19. The lamp assembly according to claim 18 wherein the power supply includes a circuit board that comprises a connector board segment with power connection elements defined as a power supply connector, and the lamp unit comprises a connector board segment with power connection elements defined as a lamp connector; and wherein the power supply connector and the lamp connector are configured to fittingly engage one another and detachably attach the base unit to the lamp unit.

20. The lamp assembly according to claim 18 wherein the lamp unit comprises a frame, a connector board, and a heat plate; and wherein the plurality LEDs are packaged as a chip on board (COB) light source module.
